(19) United States
(12) Patent Application Publication
(10) Pub. No.: US 2009/0231119 A1
(43) Pub. Date: Sep. 17, 2009

(54) REMOTE DATA COLLECTION IN AN ALARM OR SECURITY SYSTEM

(75) Inventor: Jordan S. Cohen, Collegeville, PA (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: VIKING ELECTRONIC SERVICES LLC, Grand Rapids, MI (US)

(21) Appl. No.: 12/048,001

(22) Filed: Mar. 13, 2008

(51) Int. Cl. G08B 26/00

(52) U.S. Cl. 340/518

(57) ABSTRACT

A method of remotely communicating with a control panel (CP) of an alarm system (A) so to access information about the system and its operation. A communication's connection is first established between the control panel and a remote location (R). The communications channel preferably uses the internet (I). Once a communication's link is established, a login algorithm is exchanged in order to validate permissions once complete, analog values from various detectors are retrieved, as is other requested information about the system and its operation. Different people with different responsibilities as to the system have controlled levels of access to the system. Downloaded information is used to prepare various reports as to the status of the system, necessary maintenance and repairs, and performance evaluations such as incidence of false alarms.

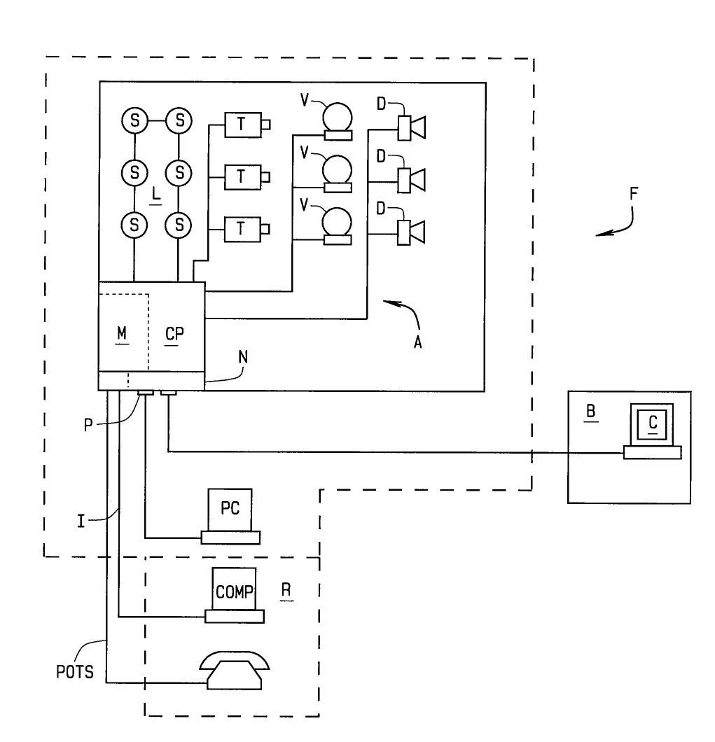

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to alarm or security systems, and more particularly to the extraction of service history information related to the operation of the system.

As is known in the art, an alarm or security system installed in a facility is operated through a control panel located on the premises. Information about the system is stored in a memory portion of the panel. Information from various sensors (fire/heat/smoke, duct, door/window, etc.) installed in one or more loops of sensors about the facility or direct to the control panel are maintained in the memory. The memory is updated, for example, every time a loop of sensors is polled. The stored information includes the response of the sensor to the poll and this information indicates if a sensor is operating properly, has failed, or is degrading in performance and should be replaced. If a sensor goes into alarm, that information is also recorded, and a history is maintained about the circumstances surrounding such instances.

Some information, for example the video output of cameras or monitors installed throughout the facility, is continuously sent to a monitoring site where it is viewed, processed, and stored. Other information stored and maintained about the system includes, for example, information about operation of cameras or video detectors, the functionality of various alarms, system upkeep, maintenance and repair, changes to the system (expansion, upgrades, etc.) is stored in a memory portion of the control panel. The memory is designed to store a substantial amount of information including the above and other diagnostic information. However, over time, the storage capacity of the memory is used and new information about the control panel and alarm system now overwrites information previously stored. Accordingly, it becomes important to access and download this information before it is lost so that people responsible for the operation, maintenance, and upkeep of the system can access this information for diagnostic and other system related purposes. Thus, it is important for persons with various responsibilities regarding the system's operation and upkeep to be able to unobtrusively access the requisite information. However, these people do not necessarily have direct physical access to the control panel to download the information pertinent to them.

### BRIEF SUMMARY OF THE INVENTION

The present disclosure is directed to a method of remotely initiating communications with a control panel for an alarm, fire alarm or security system so to access information, including diagnostic information, about the system and its operation. The method first allows for automatically establishing a communication's connection between the control panel and a remote location, the communications channel preferably being via the internet. Alternately, communications is established on-demand via a “dial up” using a plain old telephone system (POTS) or the like.

Once a communication's link is established, a login algorithm is exchanged in order to validate permissions. Analog values from various detectors are then retrieved, as is other requested information about the system and its operation. The reported information is then used to prepare various reports about the status of the system and this is useful for maintenance and upkeep of the system, evaluation of its performance, determining causes of false alarms, etc. Reports can be textual and/or graphic and can describe the operational status of individual sensors as well as that of loops of sensors, or the system as a whole.

Other objects and features will be in part apparent and in part pointed out hereafter.

### BRIEF DESCRIPTION OF THE SEVERAL VIEWS OF THE DRAWINGS

The objects of the invention are achieved as set forth in the illustrative embodiments shown in the drawings which form a part of the specification.

The sole FIGURE of the drawings is a simplified representation of an alarm/security system installed in a facility together with remote data accessing capability in accordance with the invention.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the sole drawing FIGURE, an alarm or security system indicated generally A is installed in a facility F. The security system generally includes a control panel CP through and by which operation of system A is controlled. The security system employs sensors or detectors S such as smoke and fire detectors, sensors for detecting the presence of harmful odors or chemicals, door and window sensors, etc. The sensors are installed throughout the facility in rooms and corridors, in ducts, and at windows and doors. The sensors are arranged in loops L one of which is shown in the drawing; although it will be understood that system A may have a number of such loops. The various detectors are installed in loops with other detectors of the same type.

The control panel controls operation of each loop of sensors. Thus, for example, the control panel will periodically poll the sensors in a loop to verify their operational status. The resulting information is stored in a memory M within control panel CP. If a sensor goes into alarm, the location of the sensor is stored in the memory, in addition to information as to the time of the alarm, and whether the alarm was triggered by an actual alarm condition or was a false alarm.

Alarm system A may also include one or more video monitors T located about the premises. Video output from the monitors is routed through the control panel to a remote monitoring location B where it is displayed on monitors C. In the event of an alarm, the video from the monitors is recorded for playback and later use. Other information related to the alarm; i.e., which sensor(s) has gone into alarm, is also recorded at location B.

When an alarm occurs, annunciators including both visual alarms V and audio alarms D are usually activated to warn occupants of the premises to the alarm condition so they can take appropriate action. As shown in the figure, the visual and audio alarms include a plurality of alarm units connected to, and operated by the control panel. Information about the operation of these units is provided to the control panel and stored in memory M.

As previously noted, the storage capacity of memory M is limited. Once the information to be stored in the memory exceeds the limits of the memory, the most recent data being entered now overwrites the oldest data stored therein with the result that this earlier data is lost. The control panel includes one or more data ports P by which personnel responsible for operation of system A can connect a personal computer PC or the like to the control panel, access memory M, and download information stored in the memory. However, this is not always feasible. In accordance with the present method, therefore, provision is made to access the control panel, and in particular, memory M of the control panel, using the internet so someone can readily, remotely access the memory.

Now, a person remote from the facility and not located at monitoring site B can access control panel P and memory M via the internet 1. For this purpose, control panel P includes a controller N which provides an interface between people attempting to access the control panel and the control panel. Incorporated in controller N is a protocol which must be followed in order for someone, whether trying to access the control panel locally or remotely, must satisfy. Control panel CP is given a web address so to be accessible by someone having access to the internet. When a person wishes to access the control panel from a computer COMP at a remote location R, they first access the internet in the conventional manner, and type in the web address for the control panel. Once a connection is made to the control panel, the protocol implemented by controller N first asks the user for their name or other credentials. With respect to the foregoing, there is a “login” algorithm used by the control panel and communicating party to verify the identity of the party prior to a reunion. For example, SUPPLY LOGIN CREDENTIALS is a message sent by alarm system A to the media gateway. The data payload for the message is a value expressed, for example,

f(x)=((x+24298)+99991) mod 32533

This function is applied to each of the following fields in a login request:

a=f (YYYY); YYYY is the decimal YEAR

b=f(MMDD); MM is the decimal MONTH (01-12) and DD is the decimal DAY of the month (01-31)

c=f (hhmm); hh is the decimal HOUR (00-23) and mm is the decimal MINUTE (00-59)

d=f ((ss*256)+MAC4); ss is the decimal SECOND (00-59) and MAC4 is the 4^{th} byte of the MAC address of the media gateway (or Dialer)

e=f ((MAC6*MAC5); MAC6 and MAC5 are the 6^{th} and 5^{th} bytes of the MAC address of the media gateway (or Dialer)

Item e never changes for a particular unit.
Item a only changes once a year.
Item b only changes once a day.
Items c & d can then be combined with these other items so that all the fields are changing.
For example:

cd=f(c ̂ d)

aa=a*(c ̂ d)

bb=(b*(aa & 65535))

ee=(e (c ̂ d ̂ 12345)

Each of these items fits in an unsigned longword and is combined into one final result. For example:

sprint(MacArithm, “%lu%lu%lu%lu”, cd, aa, bb, ee);
2. Login Credentials—a message sent by the medial gateway to the alarm system supplying login information
3. The media gateway will send this information only if the ‘MAC-ARITHM’ received in the ‘Supply Login Credentials’ C onversation type is correct.
4. If the ‘MAC-ARITHIM’ is incorrect, the media gateway will retry the entire login sequence beginning with the ‘Request to Login’.
5. The actual data payload for the message is depicted below.

### Login Name

### Password

### Firmware Bit

6. The firmware bit is depicted by the following
7. 0=No new firmware has been added to the media gateway
8. 1=Firmware has been changed in the media gateway since its last communication session
9. If the firmware bit is =1, once logon has been completed, the media gateway will send a conversation type ‘e-LAN Firmware Flash Results’ message to the alarm system.

If the requested information is correctly supplied, the controller then queries the user for a password. If the appropriate password is supplied, the user is then provided a menu of options with respect to the activities with which he can engage with the control panel through the controller.

It will be understood by those in the art that different persons who can access the control panel may have different responsibilities so that the menu presented by controller N to one person accessing the control panel may differ significantly from that presented someone else. The controller is pre-programmed so that, for example, one group of users can perform some activities through the control panel but not others. If the menu provided by controller N to a user includes an option for accessing memory M, then the user can now remotely access the information stored in the memory and download it to location R. Typically, the user will only be able to download data stored in the memory and cannot overwrite or erase it.

At the remote location, the information from memory M is stored in any convenient manner so that the user can access it for diagnostic purposes, historical review, and analysis. During a communication's session, analog values from, for example, smoke detectors, heat detectors, and duct detectors are retrieved. This retrieved information is then used to prepare reports depicting, for example, drift information about each sensor over some period of time. This diagnostic report can present this information in graphic form as well. Further, retrieved information can be used to evaluate how well the alarm system responded to actual and false alarms, including the possible causes of false alarms (i.e., was the cause internal or external to the system). Use of diagnostic reports enables service personnel to identify system components which need servicing, repair or replacement, so these can be timely done. Other reports can be used by system managers to identify any flaws in the systems, or areas needing possible overhauls or upgrades.

In addition to downloading information stored in memory M, accessing control panel CP from the remote location further allows system diagnostic evaluations to be performed “real time” without a technician or other service person having to physically present at the panel. Thus, for example, it is now possible to remotely upgrade the software used to run the alarm system, and check the status of the alarm system's operation in various operating modes to determine whether or not there are any “glitches” in the system.

Finally, while it is preferable to be able to remotely access control panel via the internet, it is also possible in accordance with the invention to access it using a telephone system. The protocol using the a telephone system (POTS) is similar to that with using the internet in that once a connection is made, the user must enter an access code and pass code in order to be connected to the control panel and memory M of the panel. Again, different individuals will be given different levels of access to the control panel based upon their function (service repair and maintenance, systems support, operations, etc.). However, they will be able to retrieve the same information, or perform the same operations as if the access had being via the internet.

In view of the above, it will be seen that the several objects and advantages of the present disclosure have been achieved and other advantageous results have been obtained.

Having thus described the invention, what is claimed and desired to be secured by Letters Patent is:

1. A method of obtaining information about the operational status of an alarm or security system comprising:
remotely accessing a control panel of the system in which relevant information about the operational status of the system is stored;
downloading pertinent information about the system's operation from the control panel to a remote site; and,
using the downloaded information to prepare a status report on the system.

2. The method of claim 1 in which the control panel is accessed via the internet.

3. The method of claim 1 in which the control panel is accessed using a telephone system

4. The method of claim 2 in which the control panel includes a memory in which is stored information related to operation of the system and the memory is accessed via the internet to download information stored in the memory to the remote site.

5. The method of claim 4 in which the control panel includes a controller which implements a protocol that a user attempting to access the memory must first satisfy in order to have access to the memory.

6. The method of claim 5 in which the protocol requires the user to supply a user name and password to the controller which enables the user to access the control panel memory only if the user name and password are acceptable to the controller for that purpose.

7. The method of claim 3 in which the control panel includes a memory in which is stored information related to operation of the system and the memory is accessed via the telephone system to download information stored in the memory to the remote site.

8. The method of claim 7 in which the control panel includes a controller which implements a protocol that a user attempting to access the memory through the telephone system must first satisfy in order to have access to the memory.

9. The method of claim 8 in which the protocol requires the user to supply a user name and password to the controller which enables the user to access the control panel memory only if the user name and password are acceptable to the controller for that purpose.

10. A method of obtaining information on the operational status of an alarm or security system for performing diagnostics on the system comprising:
remotely accessing a control panel of the system in which relevant information about the operational status of the system is stored;
verifying the credentials of the person accessing the system to determine both that the person is authorized to access the system and which information stored in the system the person can access;
downloading pertinent information about the system's operation from the control panel to a remote site; and,
using the downloaded information to evaluate the performance of the system and identify those components within the system needing maintenance, repair, or replacement.

11. The method of claim 10 in which the control panel is accessed via the internet.

12. The method of claim 10 in which the control panel is accessed using a telephone system

13. The method of claim 11 in which the control panel includes a memory in which is stored information related to operation of the system and the memory is accessed via the internet to download information stored in the memory to the remote site.

14. The method of claim 13 in which the control panel includes a controller which implements a verification protocol that the person must first satisfy in order to access the system.

15. The method of claim 14 in which the verification protocol requires the person to satisfy a login algorithm controller in order to access the system.

16. The method of claim 12 in which the control panel includes a memory in which is stored information related to operation of the system and the memory is accessed via the telephone system to download information stored in the memory to the remote site.

17. The method of claim 16 in which the control panel includes a controller which implements a verification protocol that the person must first satisfy in order to access the system.

18. The method of claim 17 in which the protocol requires the person to satisfy a login algorithm controller in order to access the system.
